(19) United States
(12) Patent Application Publication
(10) Pub. No.: US 2012/0042526 A1
(43) Pub. Date: Feb. 23, 2012

(54) KNIFE BLADE

(76) Inventor: Wu-Lang Chan, Yunlin County (TW)

(21) Appl. No.: 13/196,261

(22) Filed: Aug. 2, 2011

(30) Foreign Application Priority Data
Aug. 18, 2010 (TW) 099127555

(51) Int. Cl. B26B 9/00; B26D 1/14

(52) U.S. Cl. 30/357; 83/676

(57) ABSTRACT

A knife blade includes a blade body having first and second major surfaces which respectively have marginal regions that extend toward a cutting line to form a cutting edge. The cutting edge includes successive cutting edge areas, at least one of which is cut along an inclined plane to form upstream and downstream surfaces. The downstream surface is configured to extend to join one of the first and second major surfaces to form, in terms of one cutting direction, a leading edge which forms a piercing site at the corresponding cutting edge area. With the cutting edge together with the piercing site of the leading edge, a food product having soft and hard textures may be cut effortlessly.

### CROSS-REFERENCE TO RELATED APPLICATION

This application claims priority of Taiwanese Patent Application No. 099127555, filed on Aug. 18, 2010, the disclosure of which is herein incorporated by reference.

### BACKGROUND OF THE INVENTION

1. Field of the Invention

This invention relates to a knife blade, more particularly to a knife blade for a food processing apparatus for cutting a food product with hard and soft textures.

2. Description of the Related Art

There are two shapes of blades as follows: a plain-edge blade having a smooth cutting edge for cutting a soft material to form a flat cut plane on the cut material, and a serrated-edge blade having many sharp points of contact with a hard material. A serrated-edge blade is typically suitable for cutting a hard material, while cuts made with a serrated-edge blade are typically less smooth and precise than cuts made with a plain-edge blade . However, it is difficult to cut a food product with both hard and soft textures, such as satisfactorily cutting a semi-finished agar product, with either the plain-edge blade or the serrated-edge blade as mentioned above. Therefore, it is desirable to improve the aforesaid knife blade to cut a food product with hard and soft textures.

### SUMMARY OF THE INVENTION

An object of the present invention is to provide a knife blade which can easily cut a food product with hard and soft textures.

According to this invention, the knife blade includes a blade body configured to extend along a cutting line, and having first and second major surfaces which are opposite to each other in a direction transverse to the cutting line, and which respectively have first and second marginal regions. The first and second marginal regions are configured to extend toward the cutting line to join to form a cutting edge which includes successive cutting edge areas. At least one of the cutting edge areas is cut along an inclined plane relative to the cutting line to form upstream and downstream surfaces which are spaced apart from each other in a direction of the cutting line by a slant slot. The downstream surface is configured to extend to join one of the first and second major surfaces to form, in terms of one cutting direction, a leading edge which extends toward the cutting line to form a piercing site at a corresponding one of the cutting edge areas. A food product may have a soft part cut by the cutting edge, and a hard part cut by the piercing site and the leading edge, thereby rendering cutting of the food product having soft and hard textures convenient and effortlessly.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of the first preferred embodiment of a knife blade according to this invention;

FIG. 2 is a fragmentary perspective view of the first preferred embodiment;

FIG. 3 is a fragmentary side view of the-first preferred embodiment;

FIG. 4 is a schematic view of the first preferred embodiment in a state of use; and

FIG. 5 is a fragmentary schematic view of the second preferred embodiment of a knife blade according to this invention.

### DETAILED DESCRIPTION OF THE PREFERRED EMBODIMENTS

Before the present invention is described in greater detail, it should be noted that same reference numerals have been used to denote like elements throughout the specification.

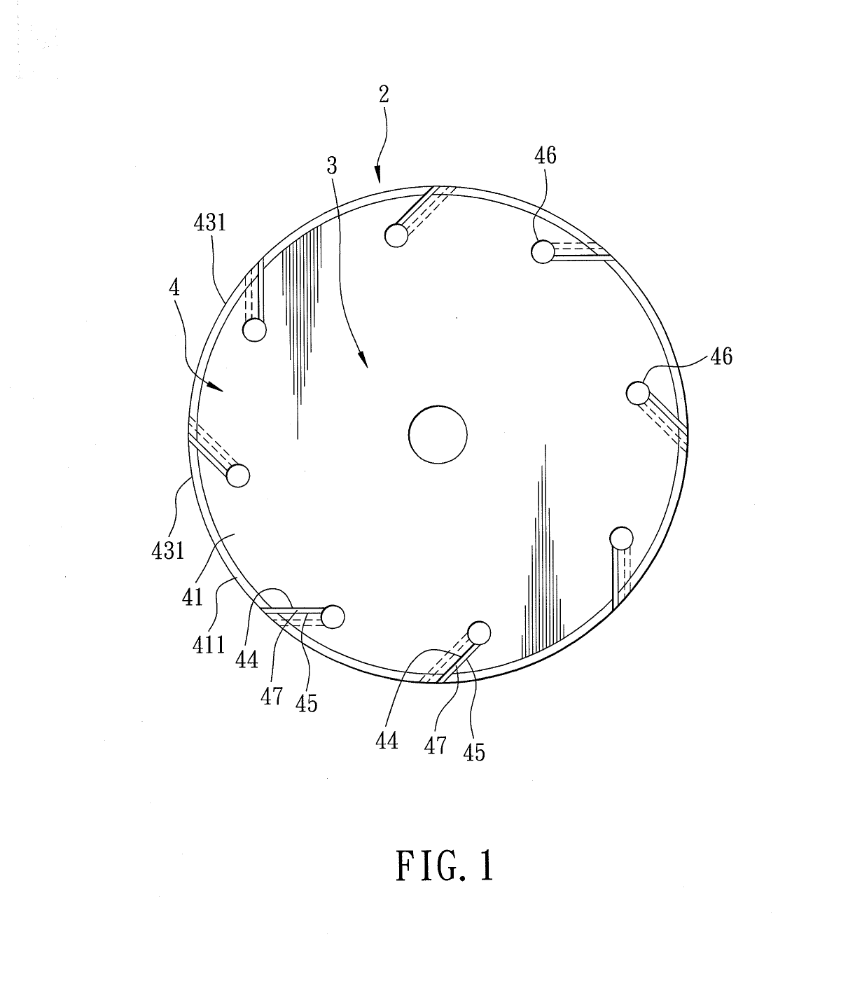

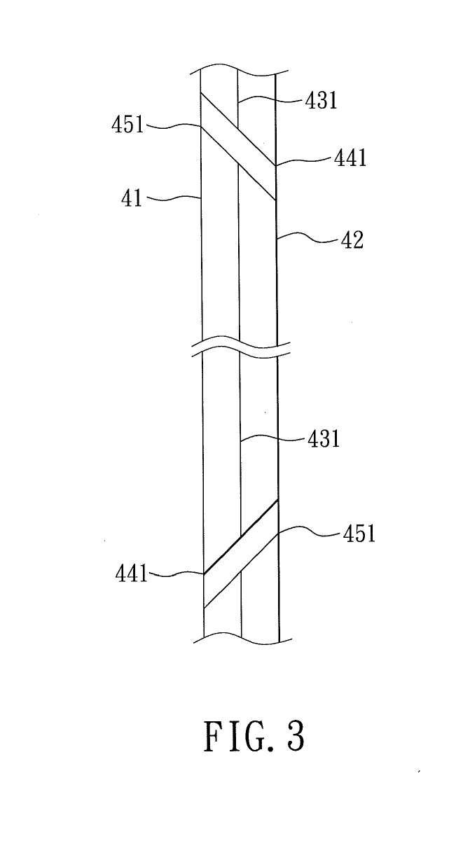

Referring to FIGS. 1 to 3, the first preferred embodiment of a knife blade according to the present invention is shown to be in the form of a one-piece circular blade 2 for use with a food processing apparatus (not shown). The circular blade 2 comprises a central region 3 and a surrounding blade body 4 surrounding the central region 3 and extending along a circular cutting line (L). The blade body 4 has first and second major surfaces 41, 42 which are opposite to each other in a direction transverse to the cutting line (L), and which respectively have first and second marginal regions 411, 421. The first and second marginal regions 411, 421 are configured to extend toward the cutting line (L) to join to form a cutting edge 43 which includes successive cutting edge areas 431.

Each of the cutting edge areas 431 is cut along an inclined plane relative to the cutting line (L) to form upstream and downstream surfaces 44, 45 which are spaced apart from each other in a direction of the cutting line (L) by a slant slot 47. The upstream and downstream surfaces 44, 45 extend through the first and second marginal regions 411, 421 and into the blade body 41 to terminate at internal edges 442, 452 that cooperatively define a collecting port 48. An enlarged cavity 46 extends through the first and second major surfaces 41, 42, and is disposed downstream of the collecting port 48 for putting away broken-off particles of a cut solid food product. An annular reinforcing rib may be further disposed around the enlarged cavity 46 to reinforce the structural strength in the slant slot 47. The downstream surface 45 is configured to extend to join one of the first and second major surfaces 41, 42 to form, in terms of one cutting direction, a first leading edge 451 which extends toward the cutting line (L) to form a first piercing site 453 at the corresponding cutting edge area 431. In this embodiment, the upstream surface 44 is configured to extend to join the other one of the first and second major surfaces 41, 42 to form, in terms of the opposite cutting direction, a second leading edge 441 which extends toward the cutting line (L) to form a second piercing site 443 at the corresponding one cutting edge area 431. Preferably, the second leading edges 441 of the upstream surfaces 44 at two consecutive ones of the cutting edge areas 431 are respectively disposed at the first and second major surfaces 41, 42, and the first leading edges 451 of the downstream surfaces 45 at two consecutive ones of the cutting edge areas 431 are respectively disposed at the first and second major surfaces 41, 42.

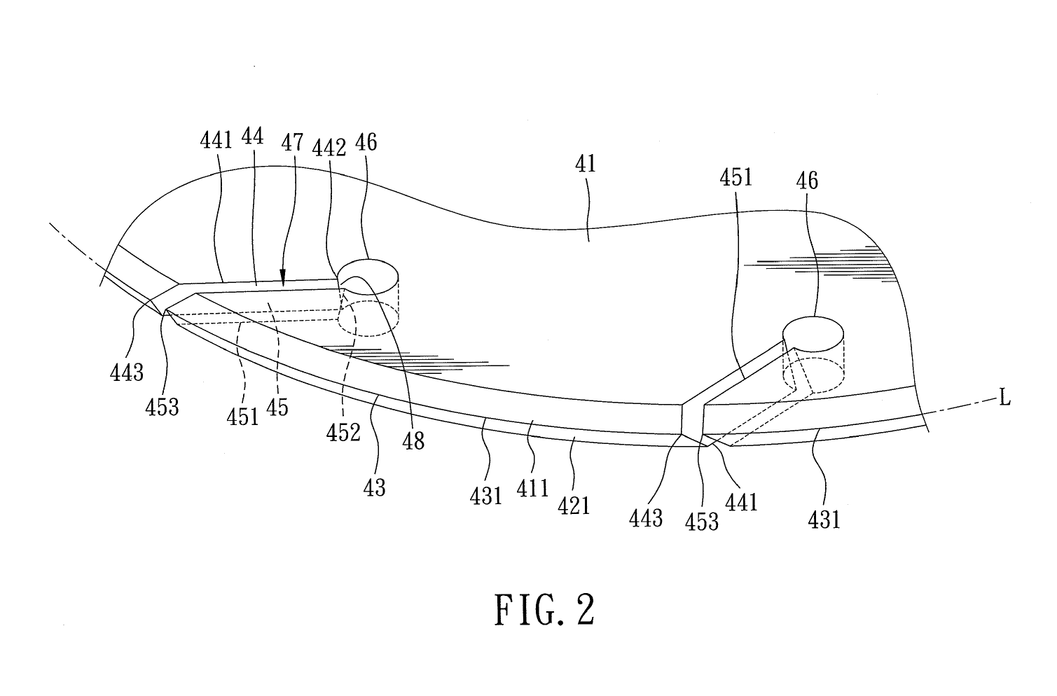

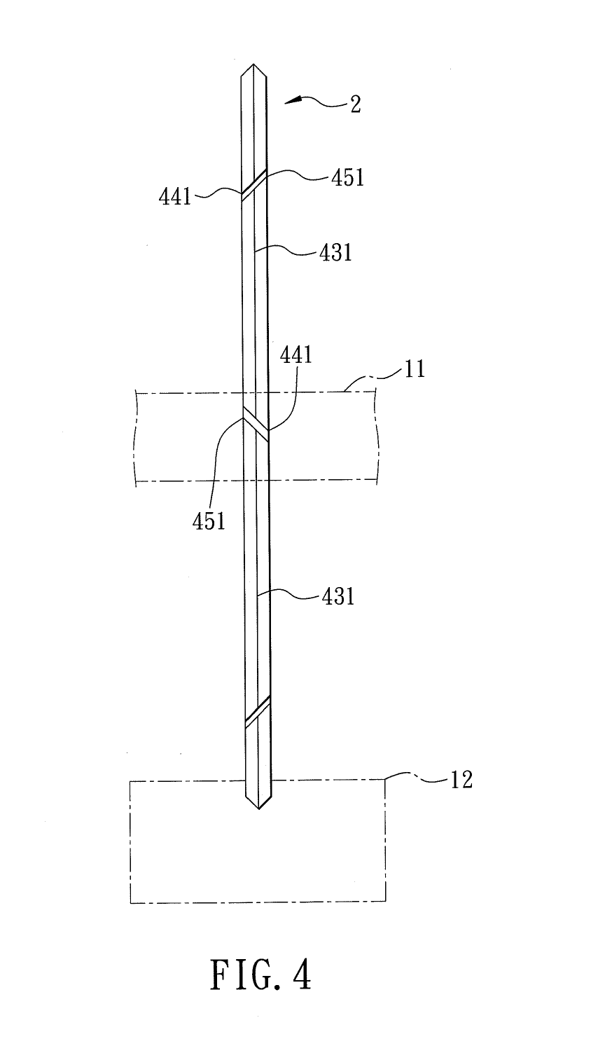

With reference to FIGS. 2 to 4, in use, the central region 3 of the circular blade 2 is mounted on a rotary spindle 11 of a food processing apparatus to cut a food product 12 moved upwardly toward a bottom portion of the circular blade 2. By rotation of the circular blade 2 with the rotary spindle 11, the cutting edge areas 431 are moved to cut the food product 12 along the cutting line (L), and the corresponding ones of the first and second piercing sites 443, 453 and the first and second leading edges 441, 451 confronting the food product 12 in terms of a cutting direction are in turn brought to pierce and cut the food product 12. Since, in this embodiment, the first (second) leading edges 441 (451) at two consecutive ones of the cutting edge areas 431 are alternately disposed at the first and second major surfaces 41, 42, the food product 12 can be cut by the first (second) leading edges 441 (451) in a left-and-right cutting manner. Briefly, the food product 12 is subject to be cut by a central part, a left side part, a central part, a right side part, a central part, and etc. of the circular blade 2 in this order.

During rotation of the circular blade 2, a food product 12 may have a soft part cut by the cutting edge areas 431, and a hard part cut by the first and second piercing sites 443, 453 and the first and second leading edges 441, 451, thereby rendering cutting of a food product 12 having soft and hard textures convenient and effortless. Furthermore, a plurality of the circular blade 2 may be mounted on the rotary spindle 11 to be rotated together for cutting a food product 12.

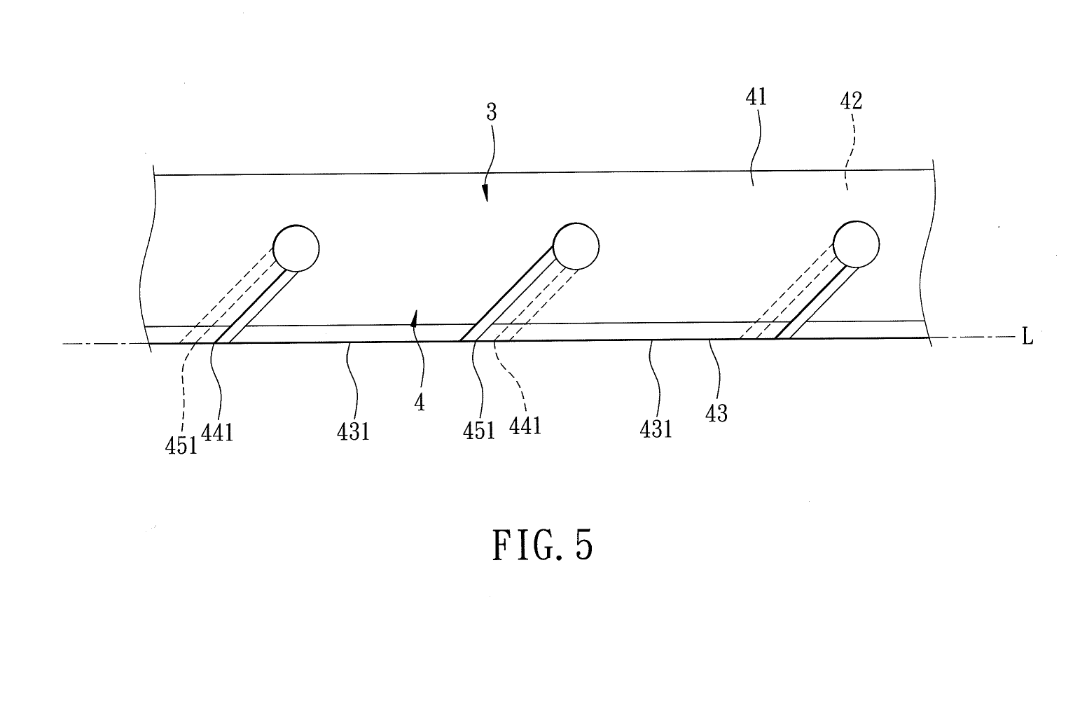

Referring to FIG. 5, the second preferred embodiment of the knife blade according to this invention is shown to be similar to the first embodiment, except that the knife blade of the second embodiment is a rectangular blade which includes an elongated spine portion 3 and an elongated blade body 4 such that the cutting line (L) is a straight line.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A knife blade comprising:
a blade body configured to extend along a cutting line, and having first and second major surfaces which are opposite to each other in a direction transverse to the cutting line, and which respectively have first and second marginal regions, said first and second marginal regions being configured to extend toward the cutting line to join to form a cutting edge which includes successive cutting edge areas, at least one of said cutting edge areas being cut along an inclined plane relative to the cutting line to form upstream and downstream surfaces which are spaced apart from each other in a direction of the cutting line by a slant slot, said downstream surface being configured to extend to join one of said first and second major surfaces to form, in terms of one cutting direction, a first leading edge which extends toward the cutting line to form a first piercing site at a corresponding one of said cutting edge areas.

2. The knife blade as claimed in claim 1, wherein said upstream surface is configured to extend to join the other one of said first and second major surfaces to form, in terms of the opposite cutting direction, a second leading edge which extends toward the cutting line to forma second piercing site at the corresponding one of said cutting edge areas.

3. The knife blade as claimed in claim 2, wherein said upstream and downstream surfaces extend through said first and second marginal regions and into said blade body to terminate at internal edges that cooperatively define a collecting port for outlet of broken-off particles of a cut solid food product.

4. The knife blade as claimed in claim 3, wherein said blade body has an enlarged cavity which extends through said first and second major surfaces, and which is disposed downstream of said collecting port for putting away the broken-off particles.

5. The knife blade as claimed in claim 2, wherein said second leading edges of said upstream surfaces at two consecutive ones of said cutting edge areas are respectively disposed at said first and second major surfaces, and said first leading edges of said downstream surfaces at two consecutive ones of said cutting edge areas are respectively disposed at said first and second major surfaces.

6. The knife blade as claimed in claim 1, wherein the cutting line is a circular line.

7. The knife blade as claimed in claim 1, wherein the cutting line is a straight line.
